(19) United States
(12) Patent Application Publication
(10) Pub. No.: US 2008/0128154 A1
(43) Pub. Date: Jun. 5, 2008

(54) Method for Producing a Winding Conductor for Electrical Appliances, and Winding Conductor Producing According to Said Method

(75) Inventors: Manfred Faust, Bremen (DE); Robert Greiner, Baiersdorf (DE); Peter Kullig, Bremen (DE); Gerhard Maul, Nurnberg (DE)

Correspondence Address: YOUNG & THOMPSON, 209 Madison Street, Suite 500, ALEXANDRIA, VA, 22314, US

(73) Assignee: SIEMENTS AKTIENGESELLSCHAFT, MUNCHEN (DE)

(21) Appl. No.: 11/792,307

(22) PCT Filed: Dec. 5, 2005
(86) PCT No.: PCT/EP05/56456

§ 371 Date: Jun. 5, 2007

(30) Foreign Application Priority Data
Dec. 6, 2004 (DE) 10 2004 058 755.8

(51) Int. Cl. H01B 7/02; B29C 47/04; B29C 49/00

(52) U.S. Cl. 174/120 R; 264/260; 264/510; 264/272.19; 264/265

(57) ABSTRACT

A method for producing a winding conductor (6a) for electrical appliances, in which one or a plurality of thermoplastic insulating layers (60) are applied by an extrusion process to an enameled wire (2) pre-insulated with a functional insulation (22), and in which each of these thermoplastic insulating layers (60) consists exclusively of a high-temperature thermoplastic. Also described is a winding conductor produced according to the method. The thickness of the insulating layer is respectively less than or equal to 25 μm. The use of a high-temperature thermoplastic as the insulating layer makes it possible to produce winding conductors for thermal classes H and F at low cost in an extrusion process.

The invention relates to a method for producing a winding conductor for electrical appliances, in particular for electrical machines and transformers. The invention also relates to a winding conductor produced according to said method.

DE 36 17 818 A1 discloses a winding conductor for magnet coils in which the metallic conductor core is provided with an enamel insulation (basic insulation) based on polyurethane PU, polyester imide PEI or THEIC polyester imide THEIC-PEI. Applied to this enamel insulation is a baked enamel layer, by which the winding conductors are fused in a winding block.

The production of such a conductor core provided with an enamel insulation (enameled wire) is generally performed by coating the bare metal wire with a polymer dissolved in a solvent, for example by spraying or by an immersion process, and subsequent drying. A suitable method for producing such a single- or multi-layered enameled wire is explained in more detail for example in DE 195 38 189 A1. As an alternative to this, it is known from DE 27 28 883 A1 to produce an enameled wire by an extrusion process, in which a melted thermoplastic material is applied in an annular form to the bare metal wire by a die and is subsequently passed together with the metal wire through a cylindrical tube, in which it is pressed onto the metal wire under pressure (pressure sheathing). However, the thermoplastic materials used are not suitable for continuous operating temperatures above 150° C.

For the winding of a conventional transformer, generally a copper wire that is provided with a single enamel insulation is used as the winding conductor. This enamel insulation is also referred to as a functional insulation and has only a low voltage endurance. When constructing a transformer, in which the primary and secondary windings are wound one on top of the other, it is therefore required to insulate them electrically from each other by additional insulating films. It is also necessary to provide lateral insulating layers, in order to bring about the leakage distances required by standards for the respective type of transformer.

For production engineering reasons and to reduce the overall size, efforts have increasingly been made in recent times to construct transformers which do not require insulating layers or insulating films. The winding conductors that are suitable for this must have a much improved voltage endurance in comparison with the conventional enamel insulation.

DE 43 36 385 A1 or U.S. Pat. No. 5,606,152 disclose winding conductors in which at least three thermoplastic insulating layers are applied to a wire without enamel insulation by the extrusion process. Mixtures of plastic are used for the individual insulating layers, on the one hand achieving separability of the individual layers and on the other hand improving the solderability, since the insulating layers are easily detached from the wire in the solder bath. One advantage of separability is that, if the outermost insulating layer is damaged, crack propagation only takes place to the surface of the second insulating layer and this layer and all layers lying further inward remain undamaged. However, these known winding conductors are only suitable for use up to thermal class B (130° C.).

In these documents, mention is also made of an embodiment of an insulated wire in which a wire enameled with polyurethane PU is extrusion-coated with three further insulating layers of a fluoropolymer. However, such an insulated wire is only conditionally suitable for use as a winding conductor, since the adhesion between the polyurethane layer and the innermost thermoplastic insulating layer and between the thermoplastic insulating layers themselves is inadequate, with the result that exertion of a tensile stress can lead to the insulating layers becoming detached from the enameled wire.

EP 0 825 623 A2 discloses winding conductors in which a plurality of insulating layers are likewise applied to a wire by extrusion, said wire being a bare metal wire or a wire provided with a functional insulation. These known winding conductors are also only suitable for use up to thermal class B.

DE 197 48 529 A1 discloses a winding wire which has one or more insulating layers of a high-temperature thermoplastic and is suitable for higher thermal classes. These high-temperature thermoplastics are applied to the bare metal wire by an extrusion process. However, it has been found in practice that the adhesion of the thermoplastic insulating layer on the bare metal wire is unsatisfactory.

The invention is therefore based on the object of providing a method for the production of a winding conductor for electrical appliances, in particular for transformers, which is also suitable for use in a higher thermal class than thermal class B. Furthermore, the invention is based on the object of providing a winding conductor produced according to this method.

With respect to the method, the stated object is achieved according to the invention by a method with the features of patent claim 1. In this method, a number of thermoplastic insulating layers, i.e. one or more thermoplastic insulating layers, are respectively applied by an extrusion process to an enameled wire pre-insulated with a functional insulation, each of these thermoplastic insulating layers consisting exclusively of a high-temperature thermoplastic. In other words, the enameled wire is surrounded by at least one insulating layer consisting of a high-temperature thermoplastic. For the purposes of the present invention, high-temperature thermoplastics are all plastics that are suitable for melt processing and can undergo continuous operating temperatures above 150°, with the exception of the group of melt-processable fluoropolymers. This group of high-temperature thermoplastics includes plastics such as polyether sulfone (PES), polyphenyl sulfone (PPSU), polyether imide (PEI), syndiotactic polystyrene (s-PS), polyphenylene sulfide (PPS), polyaryl ether ketone (PAEK), polyetherether ketone (PEEK), thermoplastic polyimide (t-PI), liquid-crystalline polymers (LCP) and some special polyarylates (PAR) and partly aromatic polyamides (PPA). The one or more insulating layers also have a thickness which is less than or equal to 25 μm.

For the purposes of the present invention, consisting exclusively of a high-temperature thermoplastic is to be understood as meaning that any copolymers that may be added for processing reasons and are not themselves high-temperature thermoplastics are present at most in such an amount that the polymer mixture obtained can still be classified in the group of high-temperature thermoplastics. In addition, customary auxiliaries for processing or additives for modifying or improving the material properties, for example plasticizers, fillers or pigments, may also be admixed with the high-temperature thermoplastic.

The enameled wire may be a commercially available enameled wire, i.e. a metal wire provided with a single- or multi-layered functional insulation for the corresponding thermal class. In this respect, the invention is based on the realization that the thermoplastic insulating layer or the thermoplastic insulating layers adhere much better on an enameled wire than on a blank metal wire.

For thermal class F, the enameled wire is, in particular, a copper enameled wire, the enamel layer of which has a grade 1 thickness with single-layer enameling of modified polyurethane, the thickness of the functional insulating layer being specified in dependence on the conductor diameter in the standards DIN EN 60 317-0-1 and DIN EN 60 317-20. For thermal class H, a grade 1 copper enameled wire with a two-layer enameling comprising modified polyester THEIC and an amide imide overcoat is preferably provided as the enameled wire, specified in accordance with DIN EN 60 317-0-1 and DIN EN 60 317-13.

Winding conductors in which an enameled wire is provided with only one thermoplastic insulating layer are referred to as winding conductors with basic insulation. In the case of two thermoplastic insulating layers, they are referred to as winding conductors with additional insulation, in the case of three or more thermoplastic insulating layers they are referred to as winding conductors with reinforced insulation. The application of one or more insulating layers, respectively consisting of high-temperature thermoplastics, to an enameled wire allows extremely thin, pore-free and voltage-proof winding conductors with basic, additional and reinforced insulation that satisfy the requirements for use in thermal classes F and H to be produced. For instance, the winding conductors with basic insulation comprising a thickness of the overall insulation (functional or enamel insulation+a thermoplastic insulating layer) of about 45 μm already exhibit a voltage endurance of >10 kV. In the case of winding conductors with reinforced insulation, the total insulating layer thickness (functional insulation+three thermoplastic insulating layers) is still well below 100 μm and the voltage endurance is greater than 18 kV.

The thickness of each individual thermoplastic insulating layer is less than or equal to 25 μm. Winding conductors with such layer thicknesses make particularly space-saving windings with adequate voltage endurance possible.

The thickness of the insulating layer may also be between 15 μm and 25 μm. Winding conductors with an insulating layer thickness in the specified range make space-saving windings with adequate voltage endurance possible and also do not have excessive porosity.

The extrusion coating is preferably performed by what is known as the blown film stretching process, in which the high-temperature thermoplastic emerges in the form of a tube from an annular die surrounding the wire and only touches the surface of the wire when it is at a distance from the annular die. The wire moved through the annular die takes up the high-temperature thermoplastic and, on account of this relative movement, subjects it to tensile stress, the thickness of the applied insulating layer being controlled by the speed of the wire. Since the overall insulation is applied in one operation, irrespective of the number of insulating layers, low-cost production of the winding conductor is possible on account of the high production rates that are possible in the case of extrusion coating and on account of the low use of material as a result of the thin insulating layers.

With the winding conductors according to the invention, instrument transformers, control-power transformers and isolating transformers for thermal classes F and H can be produced in smaller and more compact overall sizes. Dispensing with the conventional insulating films and lateral insulating layers described further above, with the simpler production that this at the same time involves, also allows such transformers to be produced at lower cost.

If two or more insulating layers of a high-temperature thermoplastic are applied, they can be applied to the wire in a single operation by the tandem and/or coextrusion process, which is particularly inexpensive.

Irrespective of how many thermoplastic insulating layers are applied, good adhesion of the thermoplastic insulating layer on the functional insulation of the enameled wire and, in the case of a number of thermoplastic insulating layers, good adhesion of the thermoplastic insulating layers to one another must be ensured. The good adhesion is a prerequisite for avoiding detachments or wrinkling and the formation of voids between individual insulating layers during later winding production. When a transformer or an electrical machine is working under operating voltage, glow and partial discharges may quickly occur in such voids, destroying the insulating layers and leading to premature failures. Good adhesion of the functional insulation and of the first thermoplastic insulating layer can be achieved if, in the extrusion coating, the wire is appropriately preheated. In the case of the enameled wire with the modified polyurethane enameling for thermal class F, this preheating temperature is 150° C.-250° C., with preference 180° C.-220° C. In the case of the enameled wire for thermal class H, it is >200° C., with preference between 300° C. and 330° C. If the enameled wire is not preheated, or only inadequately preheated, detachments and wrinkling occur during winding testing in accordance with EN 60851-3 and EN 60317-0-1 (elasticity and adhesion).

Selection of the high-temperature thermoplastics and of the extrusion process (coextrusion and/or tandem extrusion) also allows a fully separable insulating layer system to be built up, while maintaining adequate adhesion between the layers, or optionally an insulating layer system with which only a defined partial separation of individual insulating layers is possible. If, for example, a first and a second thermoplastic insulating layer of the same high-temperature thermoplastic is applied to an enameled wire by the coextrusion process, these two insulating layers are no longer separable from each other in the cooled state. The same also applies if two different thermoplastics that are compatible with each other are applied by the coextrusion process. If the coating with the same insulating materials is performed by the tandem process, the first thermoplastic insulating layer undergoing a certain cooling—for instance 50-100° C. below the processing temperature—and solidifying before the second thermoplastic insulating layer is applied, these two layers are separable from each other in the later, cooled state, but the aforementioned necessary adhesion is retained.

As in the case of all thermoplastics, it is also the case with high-temperature thermoplastics that a distinction has to be drawn between amorphous and partially crystalline thermoplastics. Examples of amorphous high-temperature thermoplastics are PES, PPSU, PEI and PAR. These have a glass transition temperature Tg (softening temperature) of about 220° C. PPS, s-PS, PAEK, PEEK, LCP and PPA are partially crystalline, with a melting point >270° C. This distinction is of significance for use in thermal class F or H, since the standard EN 60317-20 prescribes a thermal shock test at elevated temperature. For class F, this comprises the storage of a specimen which is wound around a mandrel, the diameter of which depends on the diameter of the wire, and which is under a defined winding tension (likewise dependent on the diameter of the wire) at least 175° C. for 30 minutes with subsequent testing of the voltage endurance. With otherwise the same conditions, for class H a storage temperature of at least 220° C. is prescribed. For use in thermal class F, therefore, all high-temperature thermoplastics can be applied, both as a single layer and as multiple layers in any desired sequence as the insulating layer, since the glass transition temperature Tg of the amorphous high-temperature thermoplastics lies well above the required thermal shock temperature of 175° C. For use in thermal class H, the softening temperature of the amorphous high-temperature thermoplastics is equal to the prescribed minimum storage temperature of 220° C. In the case of an enameled wire with only one thermoplastic insulating layer, in order to prevent the enameled wire under winding tension from pressing through the softened thermoplastic insulating layer, and possibly failing the subsequent voltage endurance test, in this case the thermoplastic insulating layer consists with preference of a partially crystalline high-temperature thermoplastic with a melting point >270° C. In the case of a multi-layered construction of the thermoplastic insulation, amorphous high-temperature thermoplastics may also be used for inner insulating layers, as long as the storage temperature does not exceed the required minimum temperature of 220° C. If much higher storage temperatures are required, with preference only the partially crystalline high-temperature thermoplastics should be used in the case also of a multi-layered construction.

For many applications, transformers or windings of electrical machines are impregnated with an impregnating resin. By virtue of their outstanding cost-effectiveness, unsaturated polyester resins (UP resins) or polyester imide resins (UPI) are often used for this. These impregnating resins contain reactive diluents as a component, for example monomeric styrene or vinyl toluene. These are known as extremely stress crack-inducing media. In spite of the generally high chemical resistance of all high-temperature thermoplastics, only the partially crystalline high-temperature thermoplastics exhibit adequate chemical resistance to these reactive diluents. In particular, these are PPS, PAEK, PEEK, LCP, s-PS, t-PI and PPA. Irrespective of the number of applied thermoplastic insulating layers, it is therefore of advantage if the outer insulating layer consists with preference of one of the partially crystalline high-temperature thermoplastics referred to. Such a winding conductor is then suitable for encapsulating with all impregnating resins.

With respect to the winding conductor, the object according to the invention is achieved by a winding conductor with the features of patent claim 13, the advantages of which, and similarly the advantages of the winding conductors according to the patent claims subordinated to patent claim 13, are analogously evident from the respectively assigned method claims.

For further explanation of the invention, reference is made to the drawing and the following exemplary embodiments. In the drawing:

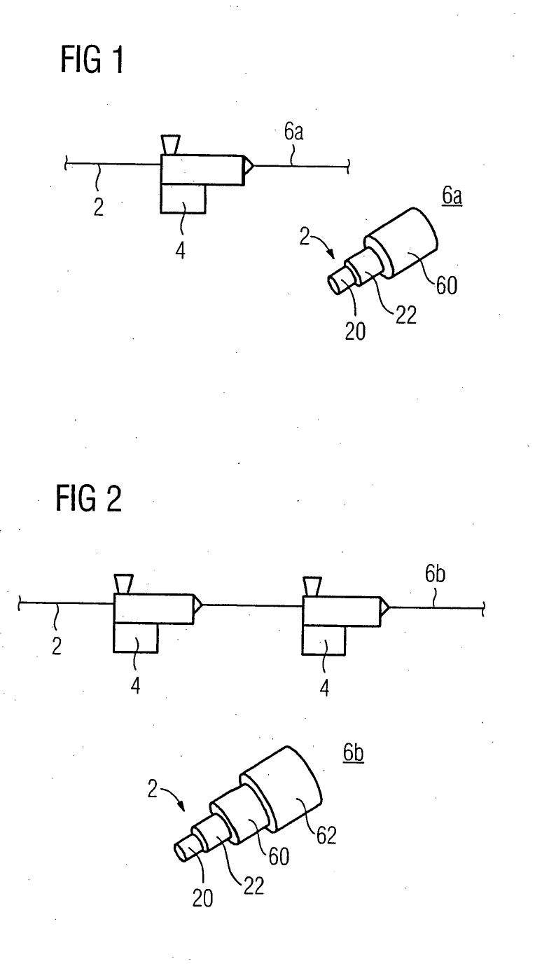

FIGS. 1-7 respectively show an extruder arrangement for the production according to the invention and a winding conductor respectively produced by this extruder arrangement, in each case in basic schematic representations.

According to FIG. 1, a pre-insulated enameled wire 2 is passed at a predetermined speed v through an extruder 4 and coated with a thermoplastic insulating layer 60 of a high-temperature thermoplastic by the blown film stretching process. The enameled wire 2 is preheated to a predetermined temperature before the extrusion coating. This preheating is preferably performed immediately before the extrusion coating, within the extruder. What is known as a basic-insulated winding conductor 6a, with only one thermoplastic insulating layer 60, emerges from the extruder 4. The enameled wire 2 comprises a bare metal wire 20, which is coated with a single- or multi-layered functional insulation 22 of an enamel. Applied to this enameled wire 2 is a single thermoplastic insulating layer 60.

FIG. 2 illustrates an extrusion process, in which the enameled wire 2 is provided with two thermoplastic insulating layers with the aid of two extruders 4, which are operated in tandem arrangement.

The end product is a winding conductor 6b with additional insulation. Applied to a first insulating layer 60 is a second insulating layer 62. The use of a tandem process allows separability between the first insulating layer 60 and the second (outer) insulating layer 62 to be set by means of the degree of cooling of the first (inner) insulating layer 60. However, the cooling should only take place to a temperature that lies approximately 50-100° C. below the processing temperature. The separability is also facilitated if two thermoplastics that are not compatible with each other are used.

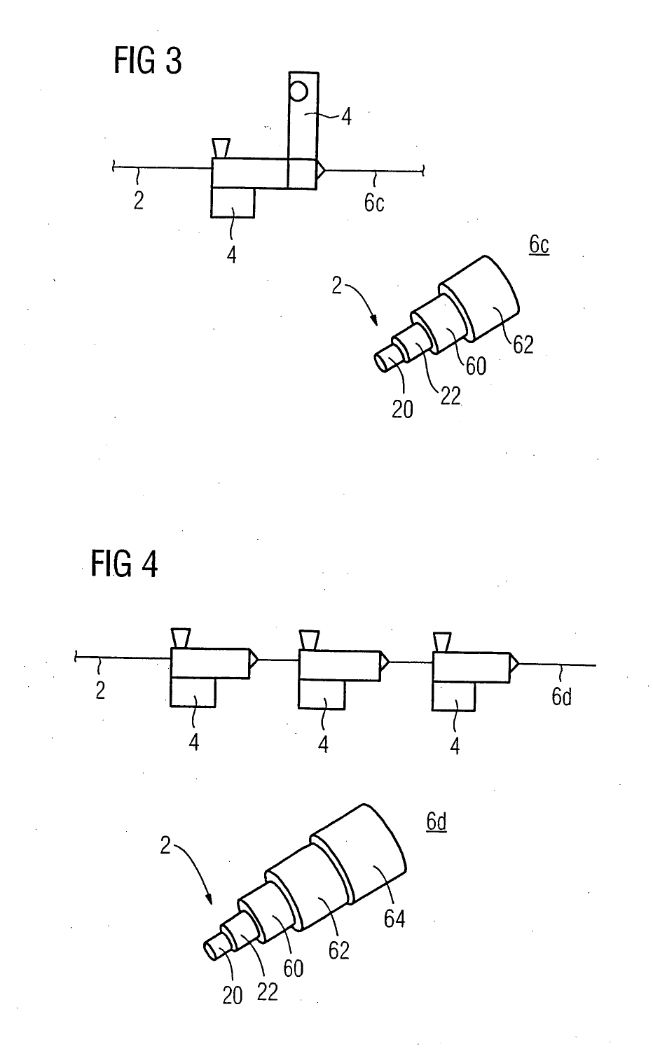

In the exemplary embodiment according to FIG. 3, the enameled wire 2 is coated with two insulating layers 60, 62 in a coextrusion process. In the case of the winding conductor 6c created in this way, the first insulating layer 60 and the second insulating layer 62 can no longer be separated from each other.

In the case of the extrusion process illustrated in FIG. 4, the enameled wire 2 is provided with three insulating layers 60, 62, 64 with the aid of three extruders 4, which are operated by the tandem process. In this way, a winding conductor 6d with reinforced insulation, which has first, second and third thermoplastic insulating layers 60, 62 and 64, is created. The tandem process allows the first (inner) insulating layer 60, the second (middle) insulating layer 62 and the third (outer) insulating layer 64 to be separated from one another.

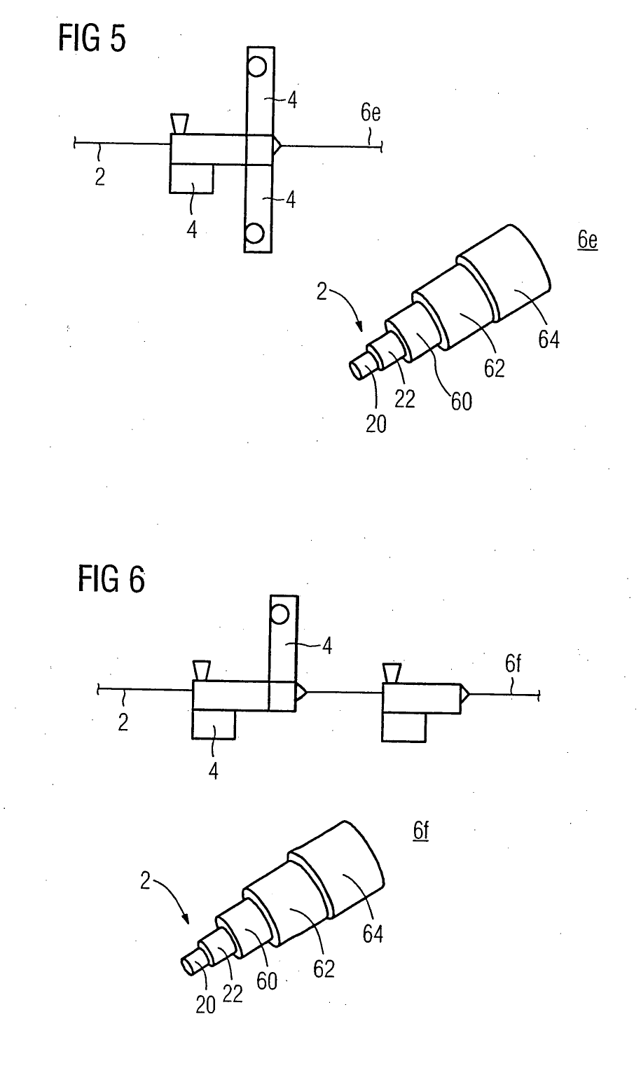

FIG. 5 shows an arrangement of three extruders 4 operated by the coextrusion process, with which the enameled wire 2 is likewise provided with three insulating layers 60, 62, 64. The insulating layers 60, 62 and 64 of the winding conductor 6e produced in this way cannot be separated from one another.

A variant in which the enameled wire 2 is likewise provided with three insulating layers 60, 62, 64 is represented in the exemplary embodiment according to FIG. 6, the two inner insulating layers 60, 62 being applied by the coextrusion process and the outer insulating layer 64 being applied with the aid of a downstream extruder 4. In the case of the triple-insulated winding conductor 6f produced in this way, the first and second insulating layers 60 and 62 cannot be separated from each other—while separability between the second and third insulating layers 62 and 64 is achieved.

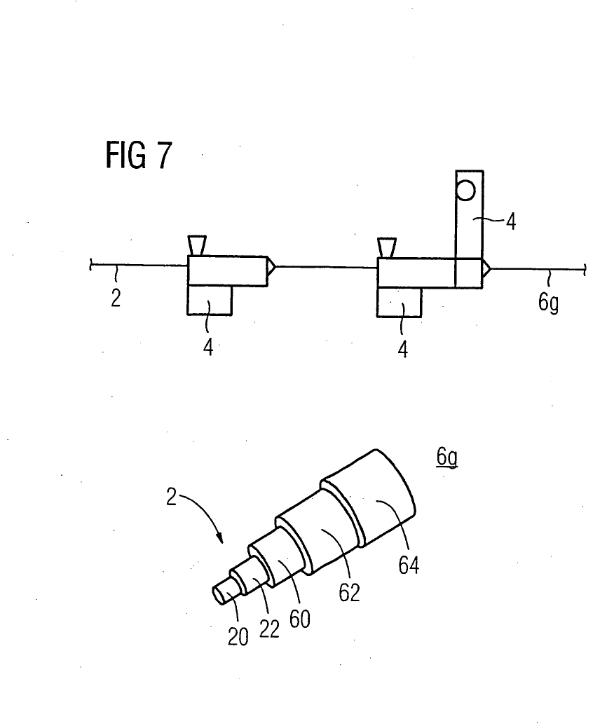

In the variant represented in FIG. 7, first of all a first insulating layer 60 is applied to the enameled wire 2 by an extruder 4 and the wire coated in this way is fed to an extruder arrangement with two extruders 4 operated by the coextrusion process. In the case of the triple-insulated winding conductor 6g created in this way, there is separability of the first and second insulating layers 60 and 62, while the second and third insulating layers 62 and 64 cannot be separated from each other.

In all the production methods represented, preheating of the enameled wire 2 is provided before the first extrusion coating. Exemplary embodiments of winding conductors that are produced by the methods respectively explained on the basis of FIGS. 1 to 7 are presented in detail below.

### 1. Exemplary Embodiments for Thermal Class F

### 1.1 Winding Wire with an Insulating Layer (FIG. 1)

### EXAMPLE 1

| | | |
|---|---|---|
| Diameter of copper conductor: | 0.8 | mm |
| Diameter of grade 1 copper enamelled wire | 0.845 | mm |
| (functional insulation with a single layer of | | |
| modified polyurethane PU): | | |
| Extrusion coating with PEEK | | |
| Preheating temperature: | 200° | C. |
| Thickness of PEEK layer: | 0.022 | mm |
| Diameter of winding wire with insulating layer: | 0.889 | mm |
| Voltage endurance: | >10 | kV |

Adhesion of the thermoplastic insulating layer on modified PU: no cracking, no wrinkling when wound around a mandrel with a diameter of 0.9 mm. Separation of functional insulation possible. Suitable for subsequent encapsulation with UP resins; other impregnating resins can also be used.

### EXAMPLE 2

### Copper Enamelled Wire According to Example 1

### Extrusion Coating with PEI

| | | |
|---|---|---|
| Preheating temperature: | 195° | C. |
| Thickness of PEI layer: | 0.023 | mm |
| Diameter of winding wire with insulating | 0.891 | mm |
| layer: | | |
| Voltage endurance: | >11 | kV |

Adhesion of the thermoplastic insulating layer on modified PU: no cracking, no wrinkling when wound around a mandrel with a diameter of 0.9 mm. Separation of functional insulation possible. Not suitable for subsequent encapsulation with UP resins; other impregnating resins can be used.

### 1.2 Winding Wire with Two Insulating Layers (FIGS. 2, 3)

### EXAMPLE 3

### FIG. 2

### Copper Enamelled Wire According to Example 1

### Extrusion Coating by the Tandem Process with PES (First Insulating Layer) and PPS (Second Insulating Layer)

| | | |
|---|---|---|
| Preheating temperature: | 205° | C. |
| Thickness of inner PES layer: | 0.022 | mm |
| Thickness of outer PPS layer: | 0.023 | mm |
| Total layer thickness of the thermoplastic | 0.045 | mm |
| insulation: | | |
| Diameter of winding wire with insulating | 0.935 | mm |
| layers: | | |
| Voltage endurance: | >14 | kV |

Adhesion of the insulating layers: no cracking, no wrinkling when wound around a mandrel with a diameter of 0.9 mm. Separation of the thermoplastic insulating layers possible, separation of functional insulation possible. Suitable for subsequent encapsulation with UP resins; other impregnating resins can also be used.

### EXAMPLE 4

### FIG. 3

### Same Copper Enamelled Wire as Example 1

### Extrusion Coating by the Coextrusion Process with PES (First Insulating Layer) and PPS (Second Insulating Layer)

| | | |
|---|---|---|
| Preheating temperature: | 205° | C. |
| Thickness of inner PES layer: | 0.023 | mm |
| Thickness of outer PPS layer: | 0.023 | mm |
| Total layer thickness of the thermoplastic | 0.046 | mm |
| insulation: | | |
| Diameter of winding wire with insulating | 0.937 | mm |
| layers: | | |
| Voltage endurance: | >14 | kV |

Adhesion of the insulating layers: no cracking, no wrinkling when wound around a mandrel with a diameter of 0.9 mm. Separation of the thermoplastic insulating layers not possible, separation of functional insulation possible. Suitable for subsequent encapsulation with UP resins; other impregnating resins can also be used.

### EXAMPLE 5

### FIG. 2

### The Same Copper Enamelled Wire as Example 1

### Extrusion Coating by the Tandem Process with PEI (First Insulating Layer) and PEI (Second Insulating Layer)

| | | |
|---|---|---|
| Preheating temperature: | 195° | C. |
| Thickness of inner PEI layer: | 0.021 | mm |
| Thickness of outer PEI layer: | 0.023 | mm |
| Total layer thickness of the thermoplastic | 0.044 | mm |
| insulation: | | |
| Diameter of winding wire with insulating | 0.933 | mm |
| layers: | | |
| Voltage endurance: | >15 | kV |

Adhesion of the insulating layers: no cracking, no wrinkling when wound around a mandrel with a diameter of 0.9 mm. Separation of the thermoplastic insulating layers possible, separation of functional insulation possible. Not suitable for subsequent encapsulation with UP resins; other impregnating resins can be used.

### EXAMPLE 6

### FIG. 3

### The Same Copper Enamelled Wire as Example 1

### Extrusion Coating by the Coextrusion Process with PEI (First Insulating Layer) and PEI (Second Insulating Layer)

| | | |
|---|---|---|
| Preheating temperature: | 195° | C. |
| Thickness of inner PEI layer: | 0.020 | mm |
| Thickness of outer PEI layer: | 0.025 | mm |
| Total layer thickness of the thermoplastic | 0.045 | mm |
| insulation: | | |
| Diameter of winding wire with insulating | 0.935 | mm |
| layers: | | |
| Voltage endurance: | >15 | kV |

Adhesion of the insulating layers: no cracking, no wrinkling when wound around a mandrel with a diameter of 0.9 mm. Separation of the thermoplastic insulating layers not possible, separation of functional insulation possible. Not suitable for subsequent encapsulation with UP resins; other impregnating resins can be used.

### 1.3 Winding Wire with Three Insulating Layers (FIGS. 4, 5, 6, 7)

### EXAMPLE 7

### FIG. 4

### The Same Copper Enamelled Wire as Example 1

### Extrusion Coating by the Tandem Process with PSU (First Insulating Layer), PPSU (Second Insulating Layer) and PEEK (Third Insulating Layer)

| | | |
|---|---|---|
| Preheating temperature: | 210° | C. |
| Thickness of inner PSU layer: | 0.022 | mm |
| Thickness of middle PPSU layer: | 0.024 | mm |
| Thickness of outer PEEK layer: | 0.022 | mm |
| Total layer thickness of the thermoplastic | 0.068 | mm |
| insulation: | | |
| Diameter of winding wire with insulating | 0.981 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers possible, separation of functional insulation possible. Suitable for subsequent encapsulation with UP resins; other impregnating resins can also be used.

### EXAMPLE 8

### FIG. 5

### The Same Copper Enamelled Wire as Example 1

### Extrusion Coating by the Coextrusion Process with PSU (First Insulating Layer), PPSU (Second Insulating Layer) and PEEK (Third Insulating Layer)

| | | |
|---|---|---|
| Preheating temperature: | 210° | C. |
| Thickness of inner PSU layer: | 0.022 | mm |
| Thickness of middle PPSU layer: | 0.024 | mm |
| Thickness of outer PEEK layer: | 0.024 | mm |
| Total layer thickness of the thermoplastic | 0.070 | mm |
| insulation: | | |
| Diameter of winding wire with insulating | 0.985 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers not possible, separation of functional insulation possible. Suitable for subsequent encapsulation with UP resins; other impregnating resins can also be used.

### EXAMPLE 9

### FIG. 4

### The Same Copper Enamelled Wire as Example 1

### Extrusion Coating by the Tandem Process with PES (First Insulating Layer), PES (Second Insulating Layer) and PES (Third Insulating Layer)

| | | |
|---|---|---|
| Preheating temperature: | 200° | C. |
| Thickness of inner PES layer: | 0.022 | mm |
| Thickness of middle PES layer: | 0.023 | mm |
| Thickness of outer PEEK layer: | 0.025 | mm |
| Total layer thickness of the thermoplastic | 0.070 | mm |
| insulation: | | |
| Diameter of winding wire with insulating | 0.985 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers possible, separation of the functional insulation possible. Not suitable for subsequent encapsulation with UP resins; other impregnating resins can be used.

### EXAMPLE 10

### FIG. 5

### The Same Copper Enamelled Wire as Example 1

### Extrusion Coating by the Coextrusion Process with PES (First Insulating Layer), PES (Second Insulating Layer) and PES (Third Insulating Layer)

| | | |
|---|---|---|
| Preheating temperature: | 200° | C. |
| Thickness of inner PES layer: | 0.022 | mm |
| Thickness of middle PES layer: | 0.024 | mm |
| Thickness of outer PES layer: | 0.020 | mm |
| Total layer thickness of the thermoplastic | 0.066 | mm |
| insulation: | | |
| Diameter of winding wire with insulating | 0.977 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers not possible, separation of the functional insulation possible. Not suitable for subsequent encapsulation with UP resins; other impregnating resins can be used.

### EXAMPLE 11

### FIG. 6

### The Same Copper Enamelled Wire as Example 1

Combined Tandem and Coextrusion Coating. Extrusion coating by the Coextrusion Process with PSU (First Insulating Layer) and PPSU (Second Insulating Layer), by the Tandem Process with PEEK (Third Insulating Layer)

| | | |
|---|---|---|
| Preheating temperature: | 210° | C. |
| Thickness of inner PSU layer: | 0.022 | mm |
| Thickness of middle PPSU layer: | 0.022 | mm |
| Thickness of outer PEEK layer: | 0.023 | mm |
| Total layer thickness of the thermoplastic | 0.067 | mm |
| insulation: | | |
| Diameter of winding wire with insulating | 0.979 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers PSU (inner) and PPSU (middle) not possible, separation of PPSU (middle) and PEEK (outer) possible, separation of functional insulation possible. Suitable for subsequent encapsulation with UP resins; other impregnating resins can also be used.

### EXAMPLE 12

### FIG. 7

### The Same Copper Enamelled Wire as Example 1

### Combined Tandem and Coextrusion Coating

### Extrusion Coating by the Tandem Process with PSU (First Insulating Layer), by the Coextrusion Process with PPSU (Second Insulating Layer) and PEEK (Third Insulating Layer)

| | | |
|---|---|---|
| Preheating temperature: | 210° | C. |
| Thickness of inner PSU layer: | 0.021 | mm |
| Thickness of middle PPSU layer: | 0.021 | mm |
| Thickness of outer PEEK. layer: | 0.022 | mm |
| Total layer thickness of the thermoplastic | 0.064 | mm |
| insulation: | | |
| Diameter of winding wire with insulating | 0.973 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers PPSU (middle) and PEEK (outer) not possible, separation of PSU (inner) and PPSU (middle) possible, separation of functional insulation possible. Suitable for subsequent encapsulation with UP resins; other impregnating resins can also be used.

### EXAMPLE 13

### FIG. 6

### The Same Copper Enamelled Wire as Example 1

### Combined Tandem and Coextrusion Coating

### Extrusion Coating by the Coextrusion Process with PPS (First Insulating Layer) and PPS (Second Insulating Layer), by the Tandem Process with PPS (Third Insulating Layer)

| | | |
|---|---|---|
| Preheating temperature: | 205° | C. |
| Thickness of inner PPS layer: | 0.023 | mm |
| Thickness of middle PPS layer: | 0.023 | mm |
| Thickness of outer PPS layer: | 0.022 | mm |
| Total layer thickness of the thermoplastic | 0.068 | mm |
| insulation: | | |
| Diameter of winding wire with insulating | 0.981 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers PPS (inner) and PPS (middle) not possible, separation of PPS (middle) and PPS (outer) possible, separation of functional insulation possible. Suitable for subsequent encapsulation with UP resins; other impregnating resins can also be used.

### 2. Exemplary Embodiments for Thermal Class H

### 2.1 Winding Wire with a Single Insulating Layer (FIG. 1)

### EXAMPLE 14

| | | |
|---|---|---|
| Diameter of copper conductor: | 0.8 | mm |
| Diameter of grade 1 copper enamelled wire | 0.845 | mm |
| (functional insulation polyester THEIC and | | |
| amide imide, two-layered): | | |
| Extrusion coating with PEEK | | |
| Preheating temperature: | 320° | C. |
| Thickness of PEEK layer: | 0.025 | mm |
| Diameter of winding wire with functional | 0.895 | mm |
| insulation: | | |
| Voltage endurance: | >10 | kV |

Adhesion of the thermoplastic insulating layer on functional insulation: no cracking, no wrinkling when wound around a mandrel with a diameter of 0.9 mm. Separation of functional insulation possible. Suitable for subsequent encapsulation with UP resins; other impregnating resins can also be used. Suitable for storage temperatures >220° C. in thermal shock testing.

### 2.2 Winding Wire with Two Insulating Layers (FIGS. 2, 3)

### EXAMPLE 15

### FIG. 2

### The Same Copper Enamelled Wire as Example 14

### Extrusion Coating by the Tandem Process with PES (First Insulating Layer) and PPS (Second Insulating Layer)

| | | |
|---|---|---|
| Preheating temperature: | 290° | C. |
| Thickness of inner PES layer: | 0.020 | mm |
| Thickness of outer PPS layer: | 0.025 | mm |
| Total layer thickness of the thermoplastic | 0.045 | mm |
| insulation: | | |
| Diameter of winding wire with insulating | 0.935 | mm |
| layers: | | |
| Voltage endurance: | >14 | kV |

Adhesion of the insulating layers: no cracking, no wrinkling when wound around a mandrel with a diameter of 0.9 mm. Separation of the thermoplastic insulating layers possible, separation of functional insulation possible. Suitable for subsequent encapsulation with UP resins; other impregnating resins can also be used. Suitable for storage temperature of 220° C. in thermal shock testing.

### EXAMPLE 16

### FIG. 3

### The Same Copper Enamelled Wire as Example 14

### Extrusion Coating by the Coextrusion Process with PES (First Insulating Layer) and PPS (Second Insulating Layer)

| | | |
|---|---|---|
| Preheating temperature: | 290° | C. |
| Thickness of inner PES layer: | 0.020 | mm |
| Thickness of outer PPS layer: | 0.020 | mm |
| Total layer thickness of the thermoplastic | 0.040 | mm |
| insulation: | | |
| Diameter of winding wire with insulating | 0.925 | mm |
| layers: | | |
| Voltage endurance: | >14 | kV |

Adhesion of the insulating layers: no cracking, no wrinkling when wound around a mandrel with a diameter of 0.9 mm. Separation of the thermoplastic insulating layers not possible, separation of functional insulation possible. Suitable for subsequent encapsulation with UP resins; other impregnating resins can also be used. Suitable for storage temperature of 220° C. in thermal shock testing.

### EXAMPLE 17

### FIG. 2

### The Same Copper Enamelled Wire as Example 14

### Extrusion Coating by the Tandem Process with t-PI (First Insulating Layer) and t-PI (Second Insulating Layer)

| | | |
|---|---|---|
| Preheating temperature: | 330° | C. |
| Thickness of inner t-PI layer: | 0.024 | mm |
| Thickness of outer t-PI layer: | 0.025 | mm |
| Total layer thickness of the thermoplastic | 0.049 | mm |
| insulation: | | |
| Diameter of winding wire with insulating | 0.943 | mm |
| layers: | | |
| Voltage endurance: | >14 | kV |

Adhesion of the insulating layers: no cracking, no wrinkling when wound around a mandrel with a diameter of 0.9 mm. Separation of the thermoplastic insulating layers possible, separation of functional insulation possible. Suitable for subsequent encapsulation with UP resins; other impregnating resins can also be used. Suitable for storage temperatures >220° C. in thermal shock testing.

### 2.3 Winding Wire with Three Insulating Layers (FIGS. 4, 6)

### EXAMPLE 18

### FIG. 4

### The Same Copper Enamelled Wire as Example 14

### Extrusion Coating by the Tandem Process with PES (First Insulating Layer), PPSU (Second Insulating Layer) and PEEK (Third Insulating Layer)

| | | |
|---|---|---|
| Preheating temperature: | 210° | C. |
| Thickness of inner PES layer: | 0.022 | mm |
| Thickness of middle PPSU layer: | 0.024 | mm |
| Thickness of outer PEEK layer: | 0.022 | mm |
| Total layer thickness of the thermoplastic | 0.068 | mm |
| insulation: | | |
| Diameter of winding wire with insulating | 0.981 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers possible, separation of functional insulation possible. Suitable for subsequent encapsulation with UP resins; other impregnating resins can also be used. Suitable for storage temperature of 220° C. in thermal shock testing.

### EXAMPLE 19

### FIG. 6

### The Same Copper Enamelled Wire as Example 14

### Combined Tandem and Coextrusion Coating, Extrusion Coating by the Coextrusion Process with PPS (First Insulating Layer) and PPS (Second Insulating Layer), by the Tandem Process with PPS (Third Insulating Layer)

| | | |
|---|---|---|
| Preheating temperature: | 285° | C. |
| Thickness of inner PPS layer: | 0.023 | mm |
| Thickness of middle PPS layer: | 0.023 | mm |
| Thickness of outer PPS layer: | 0.022 | mm |
| Total layer thickness of the thermoplastic | 0.068 | mm |
| insulation: | | |
| Diameter of winding wire with insulating | 0.981 | mm |
| layers: | | |
| Voltage endurance: | >18 | kV |

Adhesion of the insulating layers: no cracking, no wrinkling when wound around a mandrel with a diameter of 1.0 mm. Separation of the thermoplastic insulating layers PPS (inner) and PPS (middle) not possible, separation of PPS (middle) and PPS (outer) possible, separation of functional insulation possible. Suitable for subsequent encapsulation with UP resins; other impregnating resins can also be used. Suitable for storage temperatures >220° C. in thermal shock testing.

1-19. (canceled)

20. A method for producing a winding conductor (6a-g) for electrical appliances, in particular transformers and electrical machines, in which a thermoplastic insulating layer or a plurality of thermoplastic insulating layers (60, 62, 64) are respectively applied by an extrusion process to an enameled wire (2) pre-insulated with a functional insulation (22), and in which the thermoplastic insulating layer or each of these thermoplastic insulating layers (60, 62, 64) consists exclusively of a high-temperature thermoplastic, the thickness of an insulating layer (60, 62, 64) being less than or equal to 25 μm.

21. The method as claimed in claim 20, in which the thickness of an insulating layer (60, 62, 64) is between 15 μm and 25 μm.

22. The method as claimed in claim 20, in which the insulating layer (60) or the insulating layers (60, 62, 64) are applied by a blown film stretching process.

23. The method as claimed in claim 20, in which at least two insulating layers (60, 62, 64) are applied by a coextrusion process.

24. The method as claimed in claims 20, in which at least two insulating layers (60, 62, 64) are applied by a tandem process.

25. The method as claimed in claim 23, in which at least the outer insulating layer (60, 62, 64) is a crystalline or partially crystalline high-temperature thermoplastic.

26. The method as claimed in claim 20, in which, before the application of the high-temperature thermoplastic, the enameled wire (2) is heated up to a preheating temperature which, while taking into account the temperature resistance of the functional insulation (22), lies as close as possible to the processing temperature of the high-temperature thermoplastic.

27. The method as claimed in claim 20, in which the preheating temperature lies above 150° C.

28. The method as claimed in claim 27, in which the functional insulation (22) consists of modified polyurethane, and the preheating temperature does not exceed 250° C.

29. The method as claimed in claim 27, in which the functional insulation (22) is two-layered and comprises polyester THEIC and amide imide, to which a single insulating layer consisting of a partially crystalline high-temperature thermoplastic or a number of insulating layers (60, 62, 64) respectively consisting exclusively of a partially crystalline high-temperature thermoplastic is/are applied, and in which the preheating temperature is greater than 280° C.

30. The method as claimed in claim 29, in which the preheating temperature does not exceed 330° C.

31. A winding conductor (6a-g) for electrical appliances with an enameled wire (2), which is pre-insulated with a functional insulation (22) and is surrounded by a thermoplastic insulating layer or a plurality of thermoplastic insulating layers (60, 62, 64), the thermoplastic insulating layer or each of these thermoplastic insulating layers (60, 62, 64) consisting exclusively of a high-temperature thermoplastic and the thickness of an insulating layer (60, 62, 64) being less than or equal to 25 μm.

32. The winding conductor as claimed in claim 31, in which the thickness of an insulating layer (60, 62, 64) is between 20 μm and 25 μm.

33. The winding conductor as claimed in claim 31, in which the wire (2) is surrounded by at least two insulating layers.

34. The winding conductor as claimed in claim 31, in which at least the outer insulating layer (60, 62, 64) is a partially crystalline high-temperature thermoplastic.

35. The winding conductor as claimed in claim 31, in which the functional insulation (22) is two-layered and comprises polyester THEIC and amide imide, which is surrounded by a single insulating layer consisting of a partially crystalline high-temperature thermoplastic or a number of insulating layers (60, 62, 64) respectively consisting exclusively of a partially crystalline high-temperature thermoplastic.

36. The winding conductor as claimed in claim 31, in which the functional insulation (22) consists of modified polyurethane which is surrounded by an insulating layer (60, 62, 64) of an amorphous high-temperature thermoplastic.
